(19) United States
(12) Patent Application Publication
(10) Pub. No.: US 2011/0031277 A1
(43) Pub. Date: Feb. 10, 2011

(54) DEVICE FOR DISPENSING HIGHLY VISCOUS LIQUIDS AND METHOD FOR MANUFACTURE THEROF ("Soft Spoutflairs")

(75) Inventors: Wilhelmus Johannes Joseph Maas, Someren (NL); Petrus Lambertus Wilhelmus Hurkmans, Someren (NL)

Correspondence Address: Kramer Levin Naftalis & Frankel LLP, 1177 Avenue of the Americas, New York, NY, 10036, US

(73) Assignee: DISPENSING TECHNOLOGIES B.V., DN Helmond (NL)

(21) Appl. No.: 12/776,824

(22) Filed: May 10, 2010

(30) Foreign Application Priority Data
May 8, 2009 (NL) NL2002863
Sep. 11, 2009 (NL) NL2003473

(51) Int. Cl. B65D 37/00; B29C 45/00; B29C 49/06

(52) U.S. Cl. 222/207; 264/328.1; 264/572; 222/212; 222/214

(57) ABSTRACT

A device for dispensing a medium from a container is presented. In exemplary embodiments of the present invention, an exemplary container has at least one feed opening connectable to the container by means of coupling means, a dispensing conduit manufactured from substantially flexibly deformable material, and a closing means for a substantially air-tight closing of the dispensing conduit therewith. In exemplary embodiments of the present invention methods for the manufacture of such exemplary dispensing devices can include injection molding the coupling means and the dispensing conduit as a perform, and stretching, blowing or any combination of stretching and blowing a portion of the preform so as to obtain a substantially flexibly deformable, thin-walled dispensing conduit. Alternatively, for example, the coupling means and the dispensing conduit can be separately generated, and later unified or joined, such as, for example, by being ultrasonically welded together, or for example, by in-mold labeling methods, over-molding, welding (via laser, ultrasonic, radiofrequency, heat, mirror, etc.), sealing, clamping, gluing, etc. or any known technique for joining together such disparate parts. In exemplary embodiments of the present invention at least the dispensing conduit is injection molded from a thermoplastic material. In exemplary embodiments of the present invention such thermoplastic material can include, for example, polyolefins, polyamides, thermoplastic polyester elastomer (TPE) and polyethylene terephthalate (PET), or any combinations thereof.

### CROSS-REFERENCE TO RELATED APPLICATIONS:

This application claims priority to Netherlands Patent Applications Nos. NL2003473, filed on Sep. 11, 2009, and NL2002863, filed on May 8, 2009, each of which is hereby incorporated herein by this reference.

### TECHNICAL FIELD

The present invention relates to dispensing technologies, and in particular to devices for dispensing highly viscous liquids from a container, and methods for manufacturing same.

### BACKGROUND OF THE INVENTION

Conventional devices for dispensing media from a container generally comprise a form-retaining, injection-molded nozzle that forms a dispensing conduit for dispensing a medium (e.g., a viscous liquid, gel, etc.) from the container to the surrounding area. In order to prevent exposure of the medium to the ambient air, such as, for example, to prevent the medium form drying out, the dispensing conduit can generally be closed by means of a cap or cover element. However, such closures are generally insufficiently gas-tight to adequately protect the medium from exposure to the ambient air. Moreover, such a cap or cover introduces a separate part from the nozzle, which adds to manufacturing complexity, and which can become deformed (and thus no longer fit well) or even lost with repeated use.

What is needed in the art is a dispensing device that solves the above-mentioned problems of the prior art.

### SUMMARY OF THE INVENTION

A device for dispensing a medium from a container is presented. In exemplary embodiments of the present invention, an exemplary container has at least one feed opening connectable to the container by means of coupling means, a dispensing conduit manufactured from substantially flexibly deformable material, and a closing means for a substantially air-tight closing of the dispensing conduit therewith. In exemplary embodiments of the present invention methods for the manufacture of such exemplary dispensing devices can include injection molding the coupling means and the dispensing conduit as a perform, and stretching, blowing or any combination of stretching and blowing a portion of the preform so as to obtain a substantially flexibly deformable, thin-walled dispensing conduit. Alternatively, for example, the coupling means and the dispensing conduit can be separately generated, and later unified or joined, such as, for example, by being ultrasonically welded together, or for example, by in-mold labeling methods, over-molding, welding (via laser, ultrasonic, radiofrequency, heat, mirror, etc.), sealing, clamping, gluing, etc. or any known technique for joining together such disparate parts. In exemplary embodiments of the present invention at least the dispensing conduit is injection molded from a thermoplastic material. In exemplary embodiments of the present invention such thermoplastic material can include, for example, polyolefins, polyamides, thermoplastic polyester elastomer (TPE) and polyethylene terephthalate (PET), or any combinations thereof.

### BRIEF DESCRIPTION OF THE DRAWINGS

Various exemplary embodiments of the present invention shall be described below with reference to the drawings, in which:

FIGS. 1A and 1B respectively depict an injection-molded perform and a stretched injection-molded perform according to an exemplary embodiment of the present invention;

FIG. 2 depicts a cross-sectional view of an exemplary device in an open state according to an exemplary embodiment of the present invention;

FIG. 3 is a cross-sectional view of the device of FIG. 2 in a closed state;

FIG. 4A depicts a perspective view of an injection-molded form according to a second exemplary embodiment of the present invention;

FIG. 4B depicts a cut-away perspective view of the exemplary form of FIG. 4A;

FIG. 5 is a cut-away perspective view of the device of FIG. 4 as provided on a container;

FIG. 6 is a perspective view showing an initial setting-up for use step of the device of FIG. 5;

FIG. 7 is a perspective view of the device of FIG. 5 in a second setting-up for use step;

FIG. 8A is a perspective view of the device of FIG. 5 in an open state;

FIG. 8B is a cut-a way perspective view of the device of FIG. 8A;

FIG. 9A is a perspective view of the device of FIG. 5 in a closed state;

FIG. 9B is a cut-away perspective view of the device of FIG. 9A;

FIG. 10A shows an injection-molded preform according to another exemplary embodiment of the present invention;

FIG. 10B is a cut-away view of the preform of FIG. 10A;

FIG. 11A is a perspective view of the preform of FIG. 10A in stretched state;

FIG. 11B is a cut-away perspective view of the perform of FIG. 11A;

FIGS. 12A and 12B show an exemplary container with which the device of FIG. 10 can be used;

FIGS. 13-15 show successive steps of setting-up an exemplary third embodiment of the invention for use;

FIG. 16A shows an open situation of the third embodiment;

FIG. 16B is a cut-away view of the situation shown in FIG. 16A;

FIG. 17A is a cut-away view of a closed situation of the third embodiment;

FIG. 17B is a cut-away view of the situation shown in FIG. 17A;

FIG. 18 shows a situation, wherein the container shown in FIGS. 12A and 12B is connected to an apparatus;

FIG. 19 shows a fourth exemplary embodiment according to the present invention, in a closed state;

FIG. 20 shows the exemplary embodiment of FIG. 19 in an open state;

FIGS. 21-23 show successive steps for preparing the preferred embodiment of FIGS. 19 and 20;

FIG. 24 shows the fourth exemplary embodiment in an open state;

FIG. 25 shows the exemplary embodiment of FIG. 24 in a closed state;

FIGS. 26 and 27 respectively show a fifth exemplary embodiment according to the present invention in an open and closed state;

FIGS. 28-30 show successive steps for preparing the exemplary embodiment of FIGS. 26 and 27 for use;

FIG. 31 shows the exemplary embodiment of FIGS. 26 and 27 in a closed state;

FIG. 32 shows a cut-away state of the exemplary embodiment of FIG. 31;

FIGS. 33A and 33B respectively show a cut-away and perspective view of an injection-molded further exemplary embodiment of the present invention;

FIGS. 34A and 34B show a stretched form of the exemplary embodiment of FIGS. 33A and 33B;

FIG. 35 is a perspective view of the exemplary embodiment of FIGS. 33 and 34 as mounted on a container;

FIG. 36A illustrates opening the exemplary nozzle of the exemplary embodiment of FIGS. 33 and 34;

FIG. 36B is a cut-away view of FIG. 36A;

FIG. 37A shows an open state of the nozzle of FIG. 36;

FIG. 37B shows a cut-away view of FIG. 37A;

FIG. 38A depicts closing the nozzle of FIG. 36A;

FIG. 38B is a cut-away view of FIG. 38A;

FIG. 39A shows a closed state of the exemplary embodiment of FIGS. 33 and 34;

FIG. 39B is a cut-away view of FIG. 39A;

FIG. 40 depicts an exemplary container and spout according to an alternate exemplary embodiment of the present invention;

FIG. 41 depicts various parts of the exemplary embodiment of FIG. 40;

FIG. 42 illustrates how the exemplary embodiment of FIG. 40 is used;

FIG. 43 illustrates activation of the exemplary embodiment of FIG. 40; and

FIG. 44 illustrates closure details of the exemplary embodiment of FIG. 40.

The patent or application file contains at least one drawing executed in color. Copies of this patent or patent application publication with color drawing(s) will be provided by the U.S. Patent and Trademark Office upon request and payment of the necessary fee.

### DETAILED DESCRIPTION OF THE INVENTION:

In exemplary embodiments of the present invention, a device for dispensing a medium such as, for example, a liquid, mastic, gel or other highly viscous material from a container can comprise at least one feed opening connectable to the container by means of coupling means, a dispensing conduit manufactured from a substantially flexibly deformable material, and a closing means for effecting a substantially air-tight closing of the dispensing conduit.

In exemplary embodiments of the present invention, because the dispensing conduit is substantially flexibly deformable it can be closed so as to be substantially air-tight via the closing means, thereby preventing the medium in the container from coming into air or gas contact with the surrounding area. In exemplary embodiments of the present invention exemplary devices are also suitable for dispensing media under pressure or that can be brought under pressure.

In exemplary embodiments of the present invention the closing means can operate to close the flexible dispensing conduit by, for example, pushing, pulling, bending, folding, zippering and fastening or any combination thereof—essentially any closure scheme can be used that can be effected on a plastic bag, which is essentially the degree of flexibility which the flexibly deformable dispensing conduit has. The key functionality being that the dispensing conduit is sufficiently deformably flexible to be repeatedly capable of a substantially air-tight closure and then re-opening to allow full flow of the medium, and thus, given this deformable flexibility, a wide variety of actual possible closure mechanisms and schemes are available.

As noted, in exemplary embodiments of the present invention, the dispensing device can be used with a container, and the container can be, but need not be pressurized by some means. If the container is in fact pressurized, so that the medium more easily flows out of it when the dispensing device is open, such pressurization can be, for example, form any known source, including, for example, placing the container on a compressor or pump and pressurizing an inner container or air gap, applying energy to the medium via pump or piston, pre-compressing, wringing, squeezing and turning, shaking, vibrating, or any combination thereof.

In exemplary embodiments of the present invention, contact between the medium and a conventional closure, such as a cap, is prevented. The situation, that, although undesirable, frequently occurs in conventional devices, where some of the medium to be dispensed dries out and adheres to a closing cap of the container, is thus prevented as well in exemplary embodiments of the present invention.

In exemplary embodiments of the present invention, the coupling means and the dispensing conduit can be integrally manufactured and/or manufactured separately and then unified into a single whole. In such exemplary embodiments of the present invention, the opening provided in the coupling means can, for example, connect to the dispensing conduit, whereby the medium can be dispensed from the container via this opening and the dispensing conduit. When the coupling means and the dispensing conduit are integrally manufactured, for example, the number of seals required is minimal, which makes the device more reliable and easier to close.

As noted, as an alternative to being integrally manufactured, the coupling means and the dispensing conduit can also be separately manufactured and subsequently joined or unified into a single whole, such as, for example, via ultrasonic welding, or, for example, via in-mold labeling methods, over-molding, welding (via laser, ultrasonic, radiofrequency, heat, mirror, etc.), sealing, clamping, gluing, or any other known technique for joining together disparate parts. Thus, the thin-walled dispensing conduit can be manufactured separately prior to such unification, and can, for example, be manufactured from a material other than that of the coupling means.

In exemplary embodiments of the present invention, the coupling means and the dispensing conduit can, for example, be manufactured from the same material, whereby they can be integrally manufactured in simple manner and moreover need not be separated from each other for recycling when ultimately disposed of.

In exemplary embodiments of the present invention the coupling means can be, for example, substantially form-retaining, while the dispensing conduit can be, for example, substantially flexibly deformable. The form-retaining coupling means can, for example, ensure a reliable connection to the container, while the dispensing conduit can be flexibly deformable so as to enable repeated substantially gas-tight closing via the closing means.

In exemplary embodiments of the present invention, the coupling means and/or dispensing conduit can be manufactured from, for example, thermoplastics. Such thermoplastic materials can include, for example, materials from the group of polyolefins (such as modified polyethylene and polypropylene), polyamides, thermoplastic polyester elastomer (TPE) and polyethylene terephthalate (PET), or any combinations thereof.

In exemplary embodiments of the present invention, the dispensing conduit can have a wall thickness of between 0.1 mm and 1.5 mm, thereby guaranteeing on the one hand that it is sufficiently thick so as not to leak or otherwise be damaged during closure, and at the same time being sufficiently thin to allow said dispensing conduit to be flexibly deformable. Alternatively, for example, the wall thickness of the dispensing conduit can be between 0.02 mm and 1.5 mm.

In exemplary embodiments of the present invention, the closing means for closing the dispensing conduit can comprise at least one clamping element.

In exemplary embodiments of the present invention, the device can also comprise a substantially form-retaining nozzle housing which can, for example, be arranged on the coupling means and through which the dispensing conduit can be guided. Such a substantially form-retaining nozzle housing can guide the (more flexible and deformable) dispensing conduit, and can also serve as a housing for at least partially storing the dispensing conduit therein.

In exemplary embodiments of the present invention, the at least one clamping element can press the dispensing conduit shut against an inner wall of the substantially form-retaining nozzle housing. Because the nozzle housing is substantially form-retaining, a sufficiently large clamping force can, for example, be exerted on the dispensing conduit in order to provide reliable clamping and closure of the dispensing conduit.

In exemplary embodiments of the present invention, the inner wall of the nozzle housing opposite the clamping element can be provided with a clamping wall member (e.g., a protrusion from the inner wall into the nozzle housing cavity) against which the dispensing conduit can be pressed shut by means of the clamping element. The clamping wall member can, for example, protrude inward from said inner wall so that the dispensing conduit only need undergo a slight transverse displacement before it is pressed shut between the clamping element and said clamping wall member.

In exemplary embodiments of the present invention, an exemplary device can include at least two clamping elements for pressing shut the dispensing conduit there-between. By applying at least two clamping elements the dispensing conduit can be engaged simultaneously from multiple directions, and can be thus closed without being moved transversely.

In exemplary embodiments of the present invention the clamping element can be a wheel, ball or slide displaceable in the nozzle housing. Such a wheel, ball or slide can be provided displaceably in the nozzle housing such that it can be displaced between a position substantially pressing shut the dispensing conduit and a position in which the wheel leaves the dispensing conduit substantially open.

In exemplary embodiments of the present invention an exemplary dispensing device can include operating means for operating the one or more clamping elements. Such operating means can on the one hand be adapted for engaging thereon of an apparatus in which a container with a nozzle device according to the present invention can be placed. The operating means can, for example, on the other hand, themselves have the function of making the clamping elements indirectly controllable, wherein the force exerted on the operating means can, for example, be increased by means of for example a lever action in order to press the clamping elements with a greater force against each other.

In exemplary embodiments of the present invention the operating means can include an element which is slidable over the one or more clamping elements and, for example, when so slid over said clamping elements, can close the dispensing conduit shut via the one or more clamping elements.

In exemplary embodiments of the present invention the operating means can include a rod mechanism with a handle. The rod mechanism can be designed such that the force exerted on the handle is increased by means of lever action so that the clamping elements are pressed against each other as increased force is applied to the handle so as to close the dispensing conduit between such clamping elements.

In exemplary embodiments of the present invention, the nozzle housing can, for example, comprise a recess in its jacket surface, the clamping element can comprise, for example, a part protruding through the recess in the nozzle housing, wherein the protruding part positions the clamping element relative to the nozzle housing and wherein the protruding part can be engaged by the dispensing conduit such that the clamping element can be moved to a position closing the dispensing conduit by an outward directed force, this force being exerted by a medium present in the dispensing conduit. The medium present in the dispensing conduit can, for example, therefore press against the clamping element, whereby this element will move automatically to a position in which the clamping element substantially closes the dispensing conduit. Given this structure, in exemplary embodiments of the present invention an automatically closable nozzle can thus be provided.

In exemplary embodiments of the present invention, the nozzle housing can comprise in its jacket surface a further recess through which a clamping part of the clamping element can be moved. This recess can, for example, also serve to guide the clamping part of the clamping element, whereby the device is more robust and its reliability is increased.

In exemplary embodiments of the present invention the closing means can be deformable via a twisting manner for a substantially air-tight closing of the dispensing conduit. Due to such twisting the substantially flexibly deformable dispensing conduit can deform, for example, to a position in which it is substantially air-tight and the medium present in the container is thus closed in an air-tight manner from its surroundings.

In exemplary embodiments of the present invention the dispensing conduit can be, for example, fixed with one outer end to a nozzle housing and can, for example, comprise a plate part on its other outer end, wherein the plate part and the nozzle housing are rotatable relative to each other in order to thus place the dispensing conduit (i) as twistably deformed via said rotation in a substantially closed position, and (ii) when untwisted and returned to its cylindrical shape, in a substantially open position.

In exemplary embodiments of the present invention locking means can be provided for locking the plate part to the nozzle housing at least in the substantially closed position (where the dispensing conduit is twisted so as to cut-off passage of the medium and close the device). The substantially air-tight closed state of the dispensing conduit can be thus maintained by these locking means, and the dispensing conduit can be thus prevented from unintentionally deforming back to a partially open position.

In exemplary embodiments of the present invention a device can further comprise a container provided with a nozzle as described above.

The present invention also relates to a method for manufacturing a device for dispensing a medium from a container as described above, wherein the coupling means and the dispensing conduit are injection molded in one operation, or for example, where they are separately manufactured and subsequently joined or unified into one whole, such as, for example, via ultrasonic welding, or for example, in-mold labeling methods, over-molding, welding (via laser, ultrasonic, radiofrequency, heat, mirror, etc.), sealing, clamping, gluing, or any other known technique for joining together disparate parts. Thus, the thin-walled dispensing conduit can, for example, be manufactured separately prior to such unification, and can, for example, be manufactured from a material other than that of the coupling means.

In exemplary embodiments of the present invention the coupling means and dispensing conduit can be injection molded, for example, as a perform. In exemplary embodiments of the present invention a portion of the perform can then be stretched, by stretching, blowing or any combination of stretching and blowing, so as to obtain a substantially flexibly deformable, thin-walled dispensing conduit.

In exemplary embodiments of the present invention, an exemplary device can be injection molded from a material, for example, from thermoplastic materials. Said thermoplastic materials can include, for example, polyolefins (such as, for example, modified polyethylene and polypropylene), polyamides, thermoplastic polyester elastomer (TPE) and polyethylene terephthalate (PET), or any combinations thereof.

Further details of various exemplary embodiments of the present invention are next described with reference to the figures.

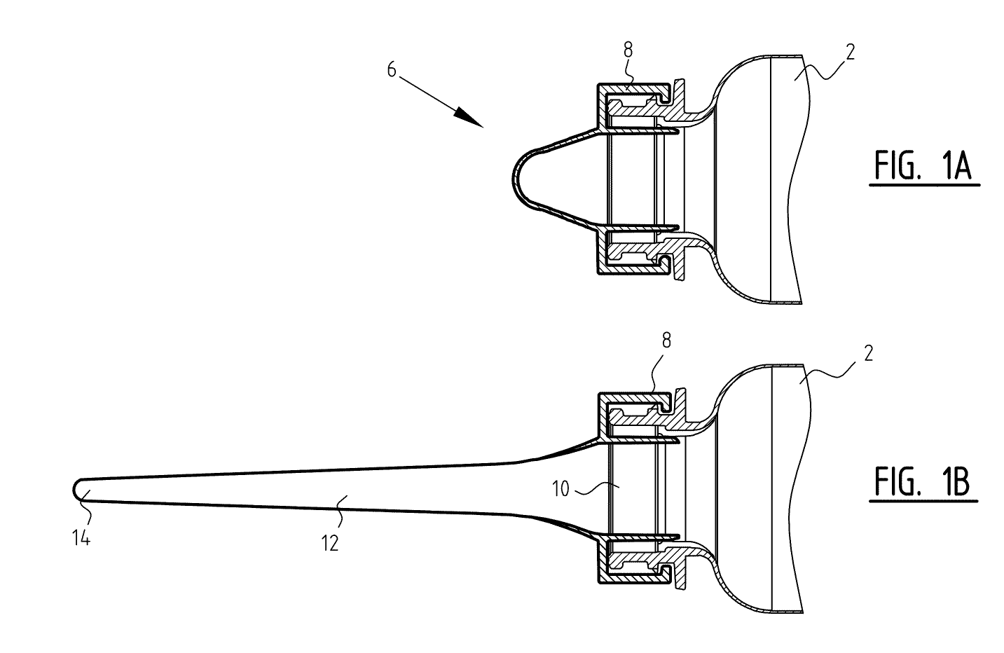

FIG. 1A depicts an injection-molded preform 6 which has coupling means 8 for attaching to a container 2. When preform 6 is stretched, such as, for example, by stretching, blowing or any combination of stretching and blowing, it can, for example, be deformed to the state shown in FIG. 1B, wherein dispensing conduit 12 with its outer end 14 is formed. Where coupling means 8 is fixed to container 2, dispensing conduit 12 has a feed opening 10. Coupling means 8 can be shape-retaining, while dispensing conduit 12, having been so stretched can be sufficiently thin-walled after stretching that it is flexibly deformable. In exemplary embodiments of the present invention the device shown in FIG. 1B can be formed in a single step by means of injection molding, or as noted above, the device can be formed of separate parts and subsequently joined or unified into a whole.

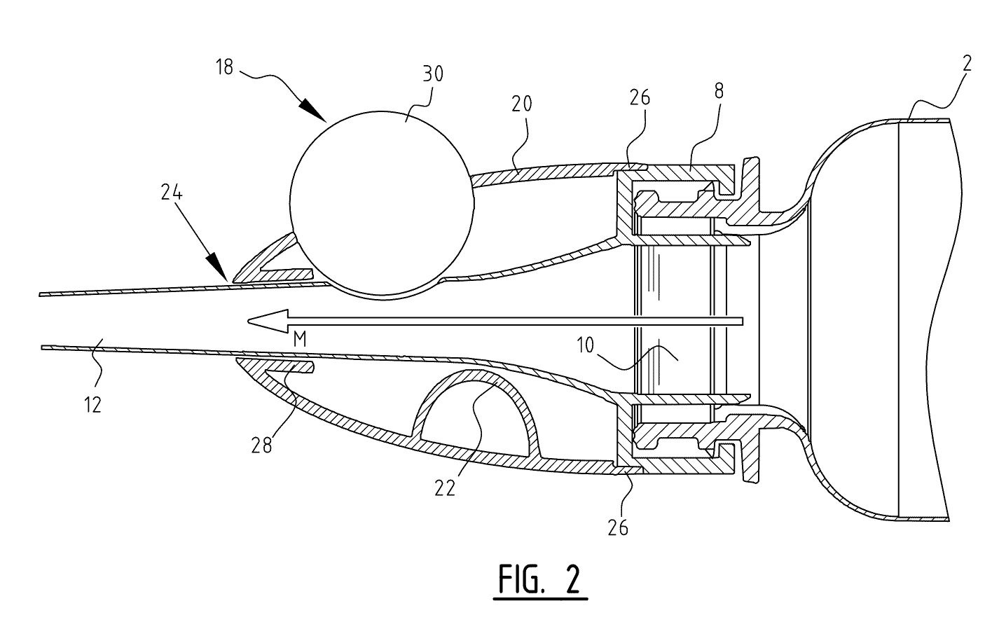

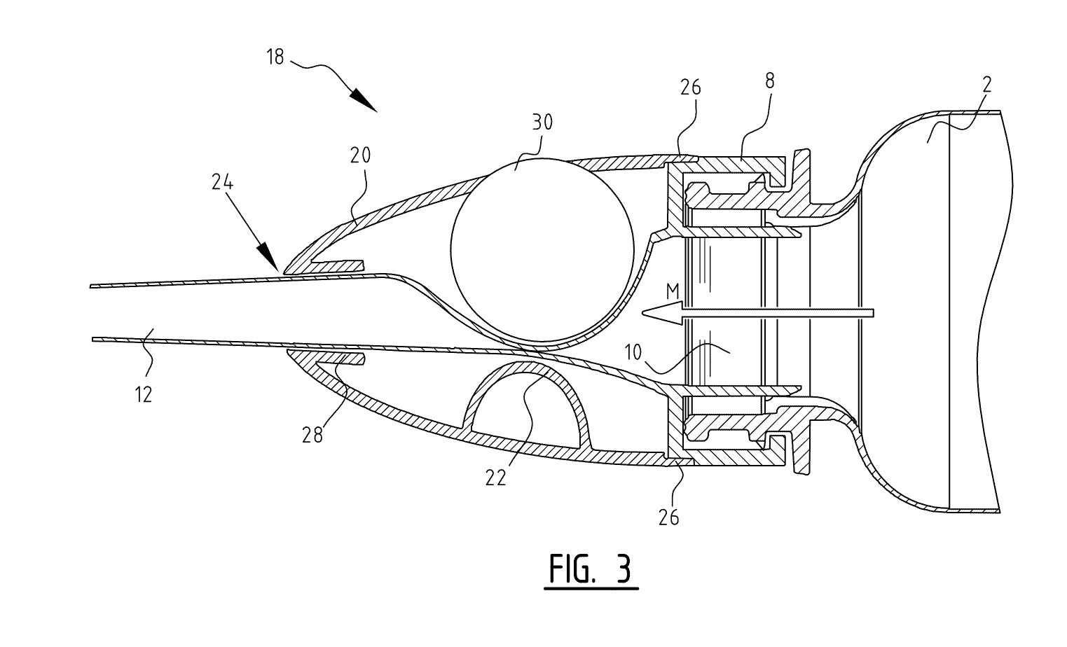

FIGS. 2 and 3 depict the unit of coupling means 8 and dispensing conduit 12 as shown in FIG. 1B as attached to container 2 with form-retaining coupling means 8, such as, for example, by means of a snap screw or clamp, etc. With reference thereto, nozzle housing 20 engages with a fixing part 26 on coupling means 8. Clamping element 18 Is provided in nozzle housing 20 for pressing closed dispensing conduit 12 that runs through nozzle housing 20.

In the exemplary embodiment of FIGS. 2 and 3, clamping element 18 can, for example, comprise a wheel 30 which can press dispensing conduit 12 closed against a clamping wall member 22 that is provided on the inner wall of nozzle housing 20, on the side opposite wheel 30. When wheel 30 is in the open situation as shown in FIG. 2, medium M in the container 2 can be dispensed through dispensing conduit 12 as shown by the arrow. Dispensing conduit 12 here runs through a tubular portion 28 of nozzle housing 20 that connects to opening 24. Tubular portion 28 can, for example, provide stiffness to nozzle housing 20 as well as guidance for dispensing conduit 12.

Those skilled in the art will understand that instead of wheel 30, for example, a ball or slide can also be used, and that the directions of opening and closing can moreover be chosen to be in any random direction. While in the embodiment shown in FIGS. 2 and 3 the opening is “forward”, i.e., away from the container, and the closing is “rearward”, i.e., towards the container, this can, for example, be reversed. Closing can also be effected by a transverse movement relative to dispensing conduit 12.

In exemplary embodiments of the present invention an exemplary dispensing device can be provided with a clamping member (not shown) which can engage with opening 24. After the exemplary device has been fully formed, and thus dispensing conduit 12 has been extended through opening 24, such clamping member can be used to close outer end 14 (FIG. 1) of dispensing conduit 12 when it is not in use. In this way any air that had been present in the portion of dispensing conduit 12 between (i) where it is clamped by wheel 30 and clamping wall member 22 and (ii) the outer end 14 of dispensing conduit 12 is prevented from contacting the medium.

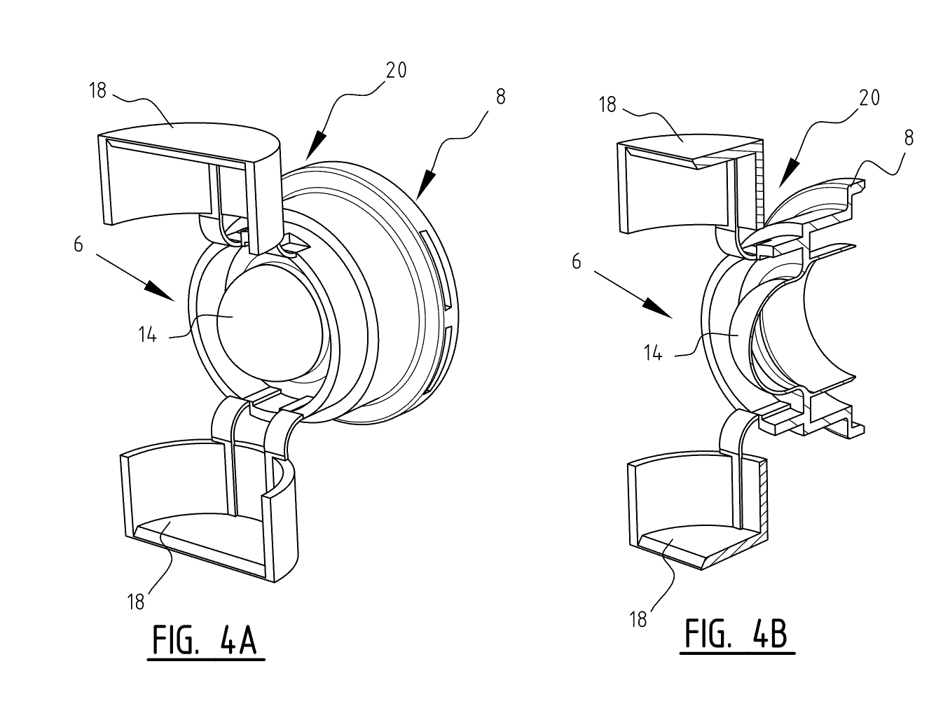

FIGS. 4-9 depict a second exemplary embodiment according to the present invention, where the part shown in FIGS. 4A and 4B is injection molded and then, for example, stretched or blown, or some combination thereof for the purpose of stretching out dispensing conduit 12. The depicted part comprises coupling means 8 for coupling to a container 2, as well as nozzle housing 20 and two clamping elements 18. Dispensing conduit 12 is here still closed at its outer end 14.

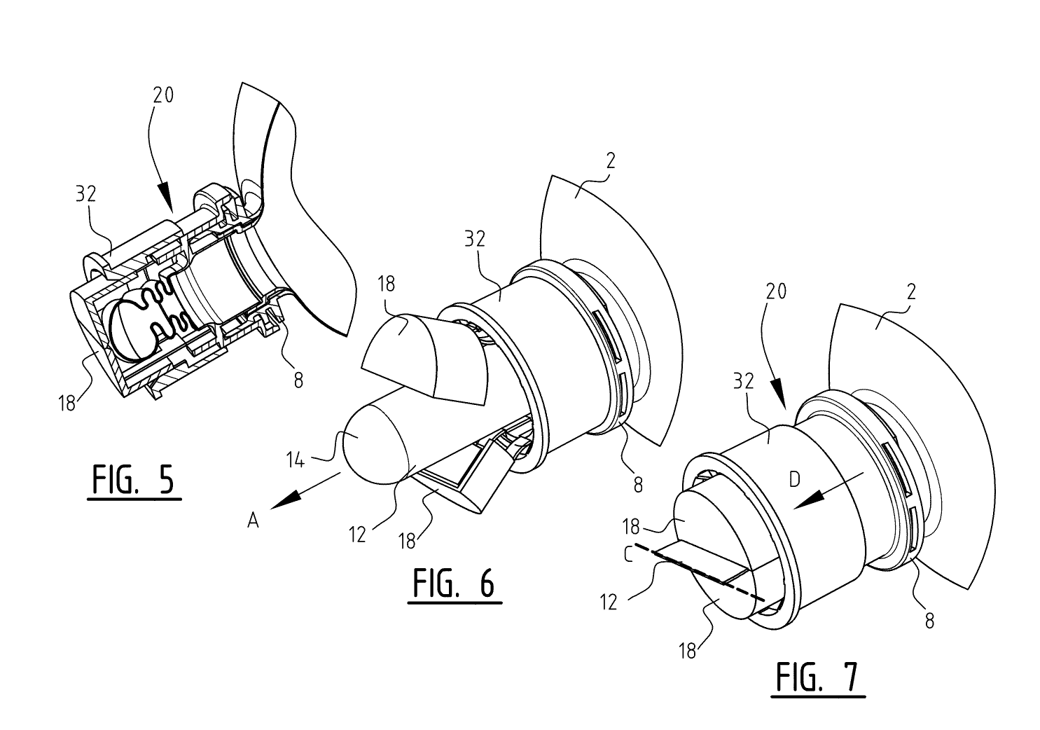

FIG. 5 depicts an exemplary configuration in which an exemplary device according to the present invention can, for example, be supplied. In FIG. 5 dispensing conduit 12 is seen as situated inside nozzle housing 20 in a compressed configuration, with clamping elements 18 in a closed state and locked by slidable element 32.

FIG. 6 shows a first step in setting up the exemplary dispensing device for use, where slidable element 32 has been pulled to the rear and the medium to be dispensed moves from container 2 into dispensing conduit 12. Clamping elements 18 have moved apart, due to (i) the resilience of the pivot element as well as (ii) pressure from the medium now moving through dispensing conduit 12.

A second set-up step of the exemplary device is depicted in FIG. 7, where slidable element 32 has now again moved forward, as shown by arrow D, and as a result, clamping elements 18 have pressed dispensing conduit 12 shut between them, resulting in the outer end 14 of dispensing conduit 12 having been severed or cut off along cutting line C.

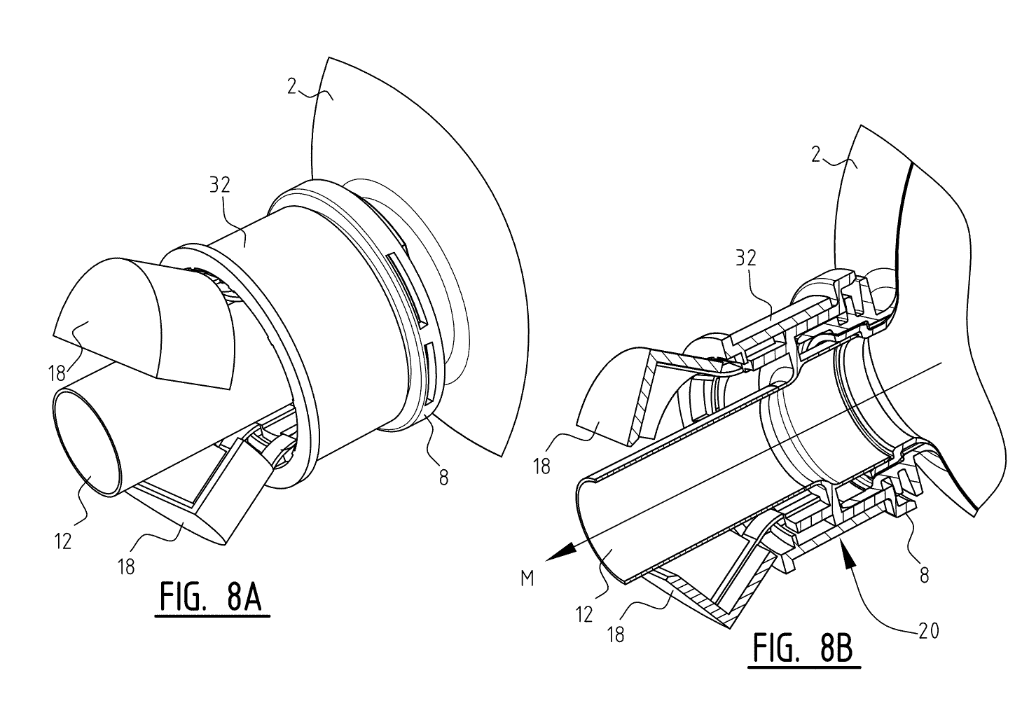

As shown in FIG. 8, when annular slidable element 20 is now once again moved away from clamping elements 18 back towards container 2, clamping elements 18 open and the medium M can be dispensed from container 2 via the now created opening in dispensing conduit 12 (as shown by the arrow).

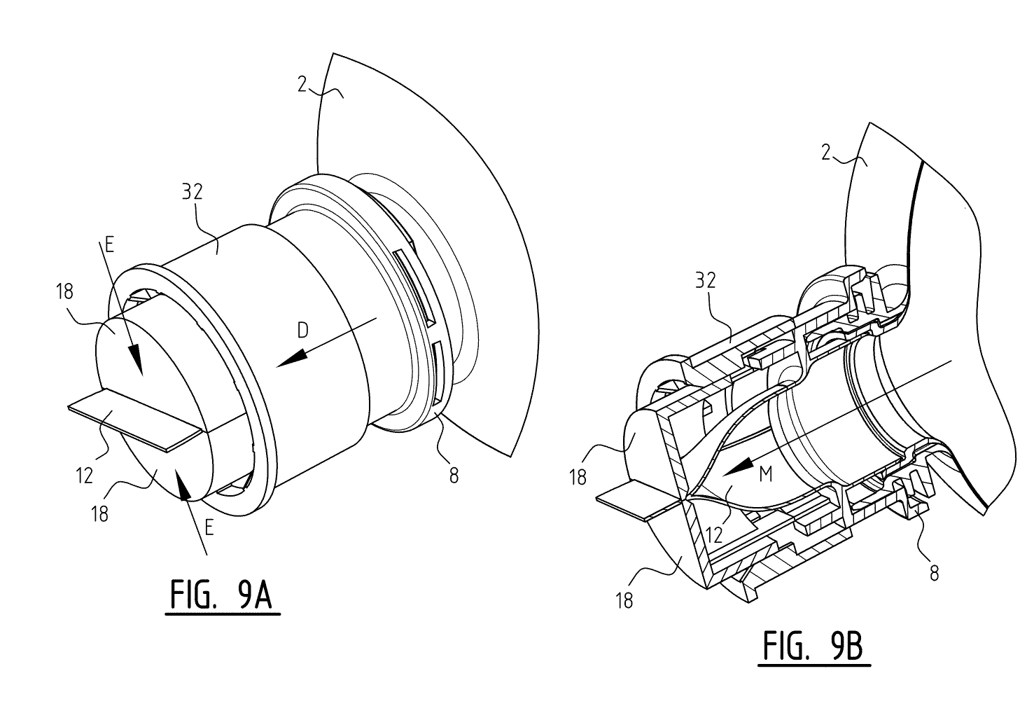

By moving annular slidable element 32 once again forward (away from container 2) as shown by arrow D, clamping elements 18 once again moved toward each other in the directions of arrows E, as shown in FIG. 9A, whereby they then press dispensing conduit 12 shut. Because the medium is now closed off in a substantially air-tight manner, no air (or other gasses in the surrounding environment) which could potentially cause the medium to dry out, or that would otherwise adversely affect the medium, can enter.

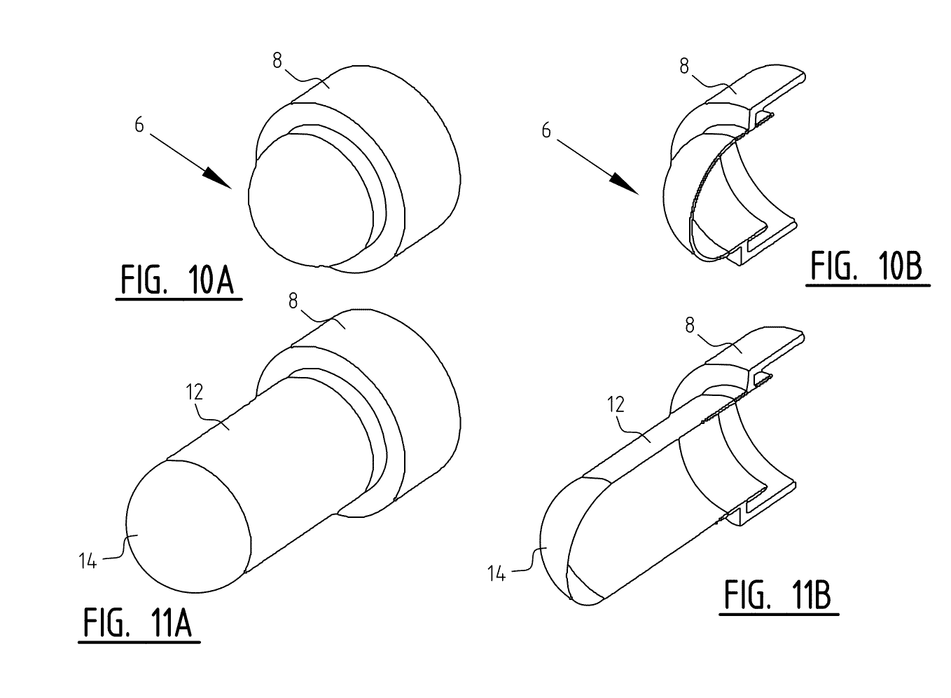

As noted above, in exemplary embodiments of the present invention, a preform of the dispensing device can be injection molded and then the preform can be treated in some way post-molding to create the final device which contains a flexible dispensing conduit. FIG. 10 illustrates an example of this process. FIG. 10A shows an injection-molded preform 6 that includes coupling means 8. FIG. 10B shows a cut-away view of this preform. When the preform is stretched, as described above, a substantially thin-walled dispensing conduit 12 with an outer end 14 can be formed, as shown in FIGS. 11A and 11B.

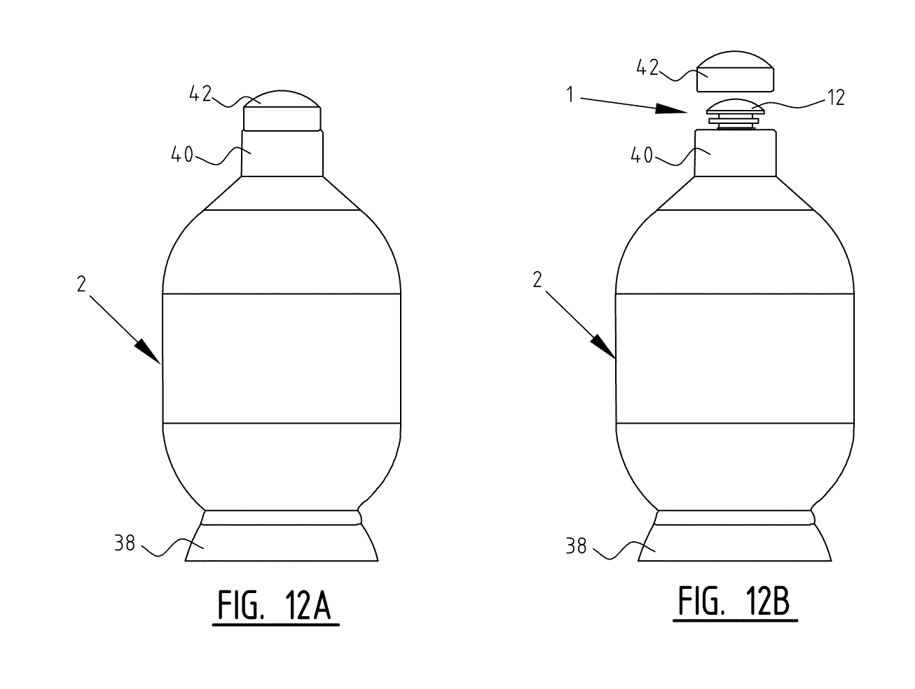

FIG. 12A shows a container 2 with base 38 and neck 40 on which a cap 42 is provided. As shown in FIG. 12B, when 42 is removed from neck 40 of container 2, dispensing conduit 12 is visible. Dispensing conduit 12 thus provides a nozzle to container 2 by which a medium contained therein can be dispensed.

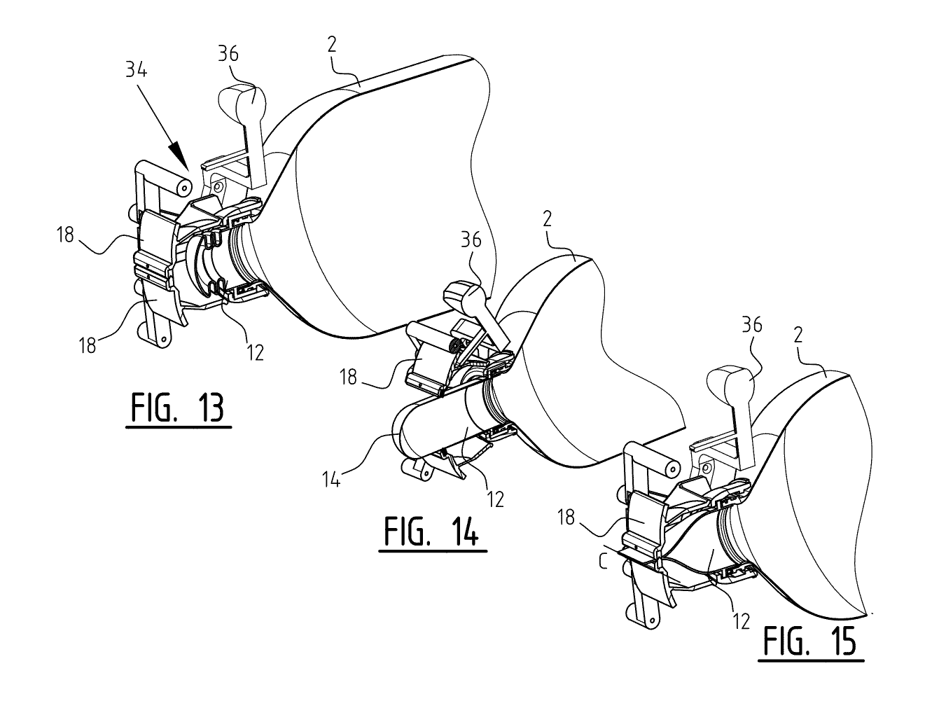

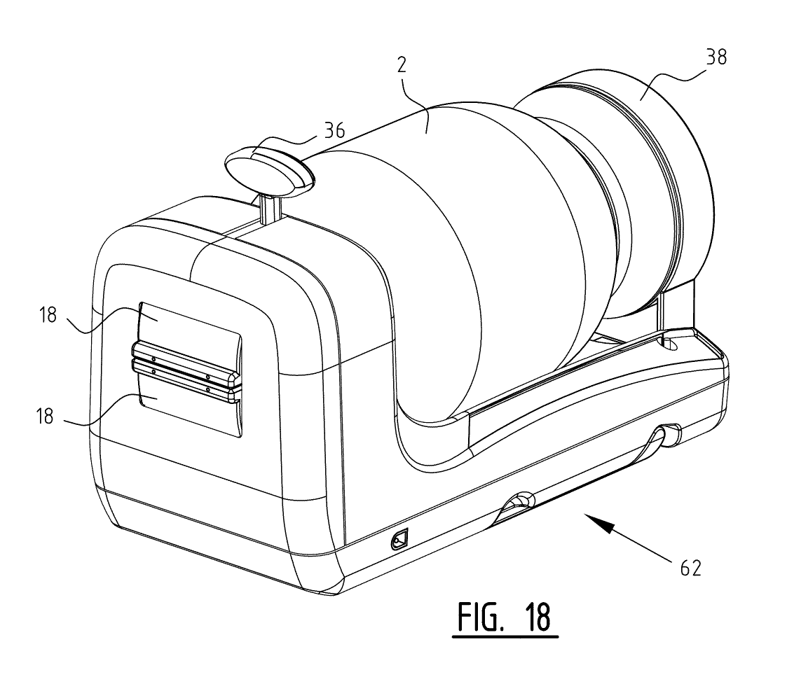

FIGS. 13-15 show successive steps for setting up container 2 with nozzle 1 for use, as shown in FIG. 12B. When container 2 is placed with nozzle 1 in, for example, dispensing apparatus 62 (as shown FIG. 18), container 2 is, for example, situated horizontally as shown in FIG. 13. In a stored configuration, dispensing conduit 12 is compressed and held behind clamped-together clamping elements 18. Clamping elements 18 can be operated, for example, using a handle 36 via rod mechanism 34.

When handle 36 is moved forward and rod mechanism 34 moves clamping elements 18 apart, as shown in FIG. 14, dispensing conduit 12 is given the freedom to expand. Since dispensing conduit 12 is still closed at its outer end 14, medium flowing from container 2 into dispensing conduit 12 cannot yet be dispensed.

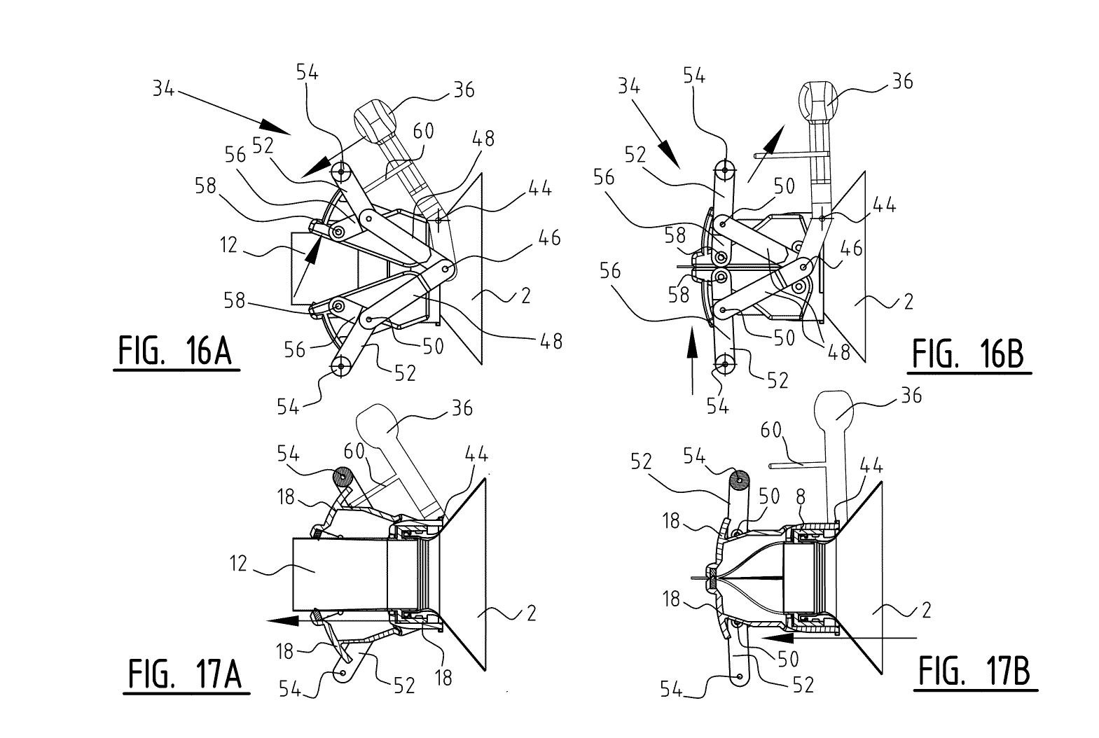

In order to make dispensing conduit 12 suitable for dispensing, it is clamped between clamping elements 18, after which the dispensing conduit is severed or cut along line C shown in FIG. 15, in similar fashion as the exemplary embodiment shown in FIG. 7. When clamping elements 18 are then moved apart by operating handle 36 via rod mechanism 34 as shown in FIGS. 16B and 16A (showing progressively opening clamping elements 18 in that order), medium can then be dispensed from container 2 via dispensing conduit 12.

When a user desires, the dispensing of the medium can then be stopped by closing dispensing conduit 12 using clamping parts 18, as is shown in FIGS. 17A and 17B. With reference thereto, rod mechanism 34 consists of a handle 36 which is connected via a fixed pivot point 44 to pivot point 46 (shown in FIG. 16) at the outer end of handle 36. Connecting rods 48 connect pivot point 46 to pivot point 50 between connecting rods 48 on the one hand and rods 52 and 56 on the other. Rods 52 are pivotable around a fixed pivot point 54, while rods 56 comprise a pivot point 58 which is fixed to clamping element 18. When handle 36 is moved forward by a user, as shown in FIG. 16A, clamping elements 18 can thus open via rod mechanism 34. This mechanism can be provided in a dispensing apparatus for example, such as, for example, dispensing apparatus 62 shown in FIG. 18. In such exemplary dispensing apparatus, handle 36 protrudes therefrom and clamping elements 18 are visible.

As shown in FIGS. 17A and 17B, when handle 36 is moved rearward, rod mechanism 34 ensures that clamping elements 18 move once again to a position in which they close dispensing conduit 12 shut.

In exemplary embodiments of the present invention, a protruding part 60 can, for example, be arranged on handle 36 for limiting the forward extension of handle 36. In the embodiment shown in FIG. 16, for example, protruding part 60 engages with clamping element 18 when in its extreme forward position.

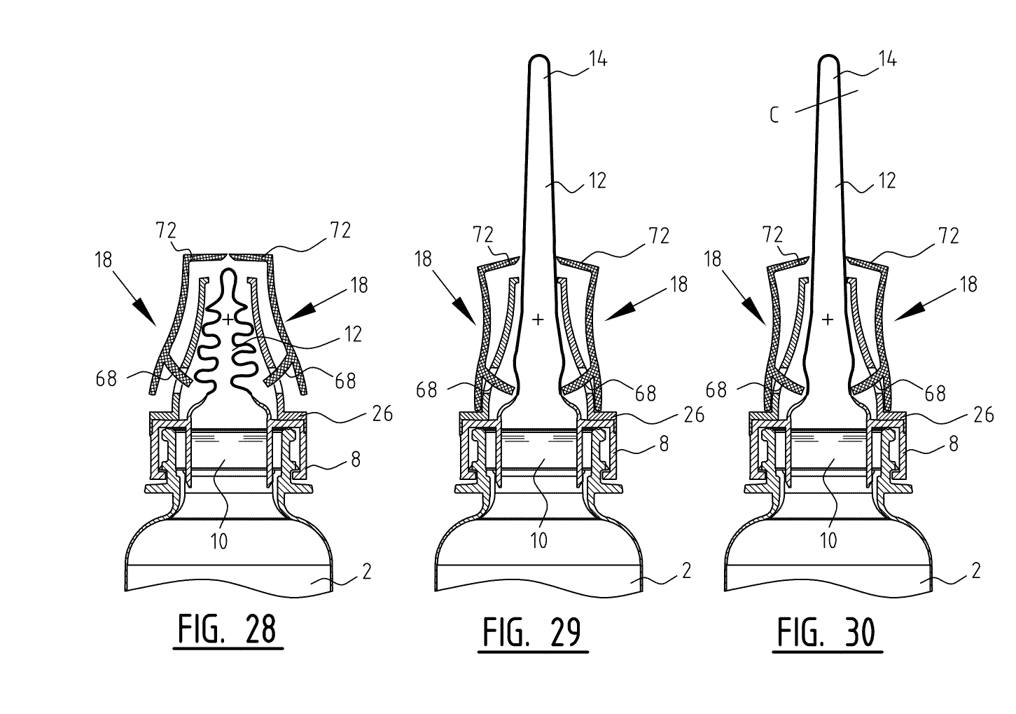

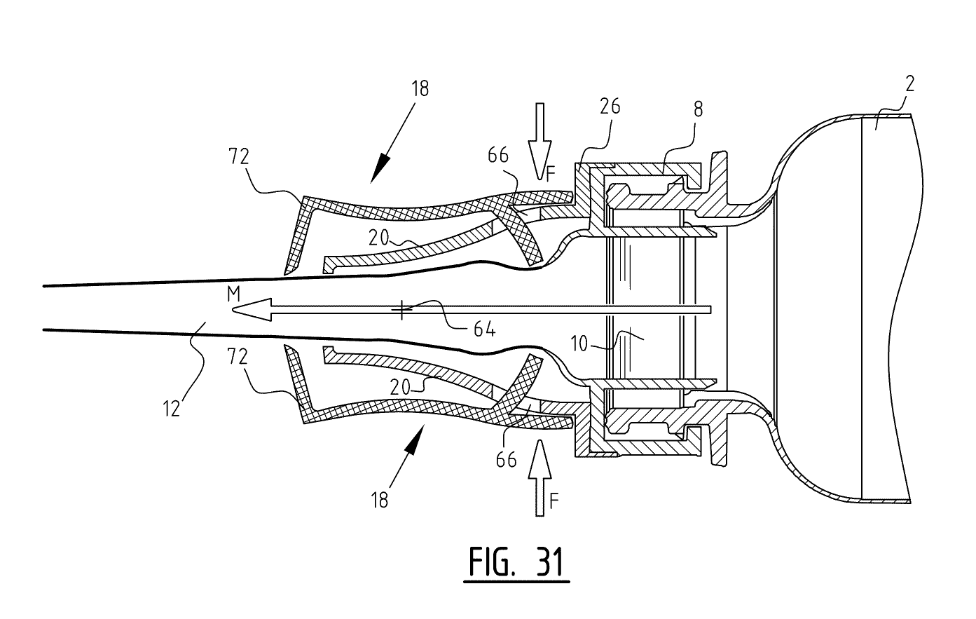

FIGS. 19-32 depict two exemplary embodiments of the present invention where an exemplary dispensing device is provided with a nozzle 1 that has at least one clamping element 18 arranged to provides an automatic closure of dispensing conduit 12. These exemplary devices are next described.

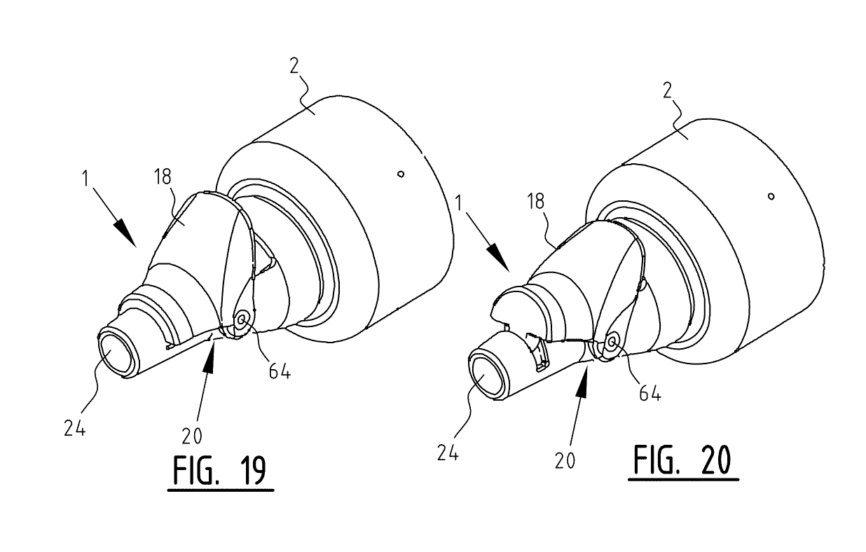

With reference to FIG. 19 there is seen an exemplary embodiment of the present invention where nozzle 1 is mounted on a container 2. Nozzle housing 20 has on its outer end (outer in the sense of remote from container 2) an opening 24, through which dispensing opening 12 (not shown) of the device can extend. Clamping element 18, mounted pivotally on nozzle housing 20 via pivot 64, is in a closed position in FIG. 19, and is likewise shown in an open position in FIG. 20.

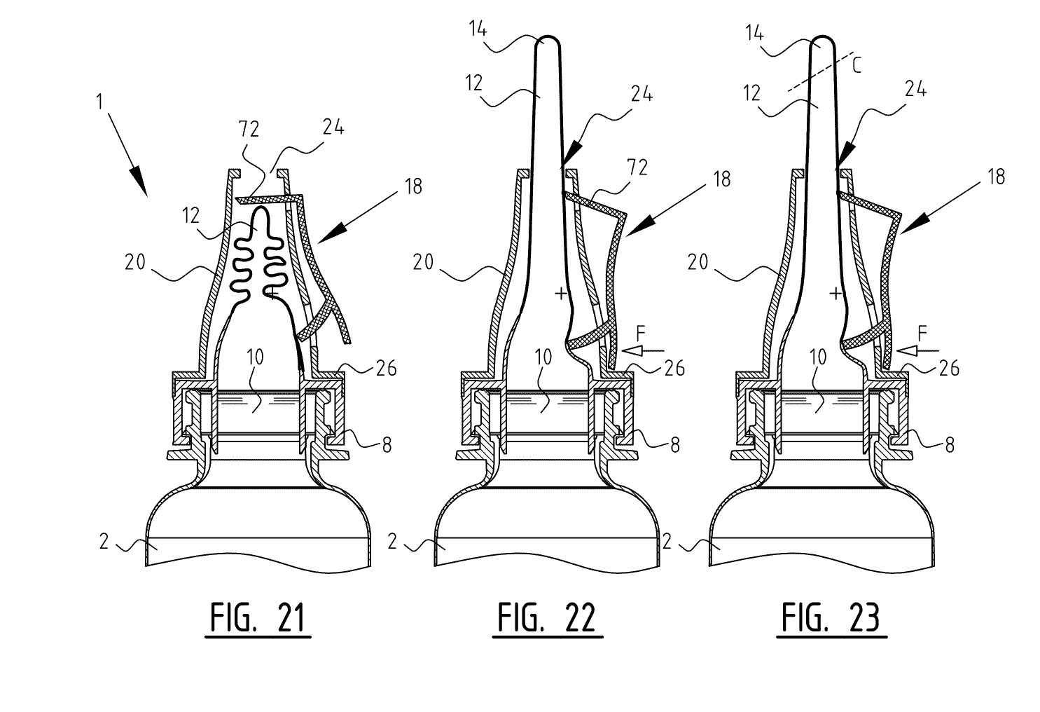

FIGS. 21-23 depict exemplary steps for setting-up such a nozzle device 1 into use. With reference thereto, FIG. 21 shows the state of this embodiment when it is first sold. In such state, dispensing conduit 12 is situated inside nozzle housing 20 and clamping element 18 closes opening 24 of nozzle housing 20 with clamping part 72. Nozzle housing 20 is attached via fixing part 26 to coupling means 8, which are integrally formed with dispensing conduit 12, and comprise an opening 10 for feeding medium from container 2 into dispensing conduit 12. Nozzle 1 is attached to container 2 via coupling means 8.

In a first set-up step a force F is exerted on clamping element 18, whereby it tilts about pivot point 64 (as shown in FIGS. 19-20) and clamping part 72 of clamping element 18 substantially exposes opening 24 of nozzle housing 20. As the medium is then displaced from container 2 into dispensing conduit 12, the latter can expand to the position shown in FIG. 22. Because, however, dispensing conduit 12 is still closed at its outer end 14, dispensing conduit 12 extends distally. Dispensing conduit 12 can then, for example, be opened at its outer end 14 by severing or cutting across it, such as, for example, along line C, as shown in FIG. 23, after which the medium can be dispensed from container 2 via dispensing conduit 12.

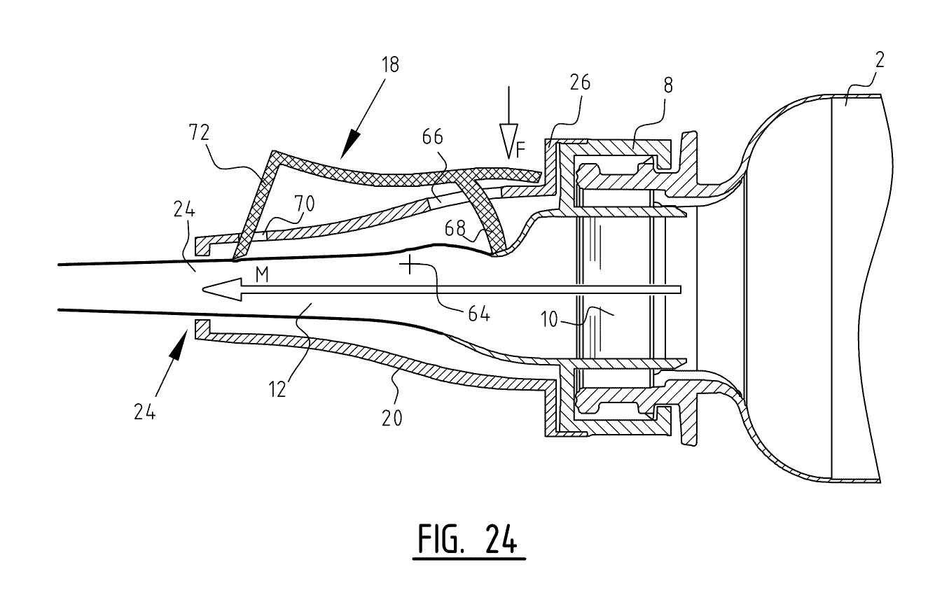

An open state for dispensing medium is shown in FIG. 24, where clamping element 18 remains forced into its open position by force F (shown by the arrow), and thus clamping part 72 of clamping element 18 leaves opening 24 substantially clear. To facilitate such clearing of opening 24, clamping element 18 pivots about pivot element 64 and is connected to dispensing conduit 12 via protruding part 68 and clamping part 72. Nozzle housing 20 is provided for this purpose with recess 66 for protruding part 68, as well as recess 70 for clamping part 72. Thus, in this open configuration of FIG. 24, medium can be dispensed—as shown by arrow M—from container 2 via dispensing conduit 12.

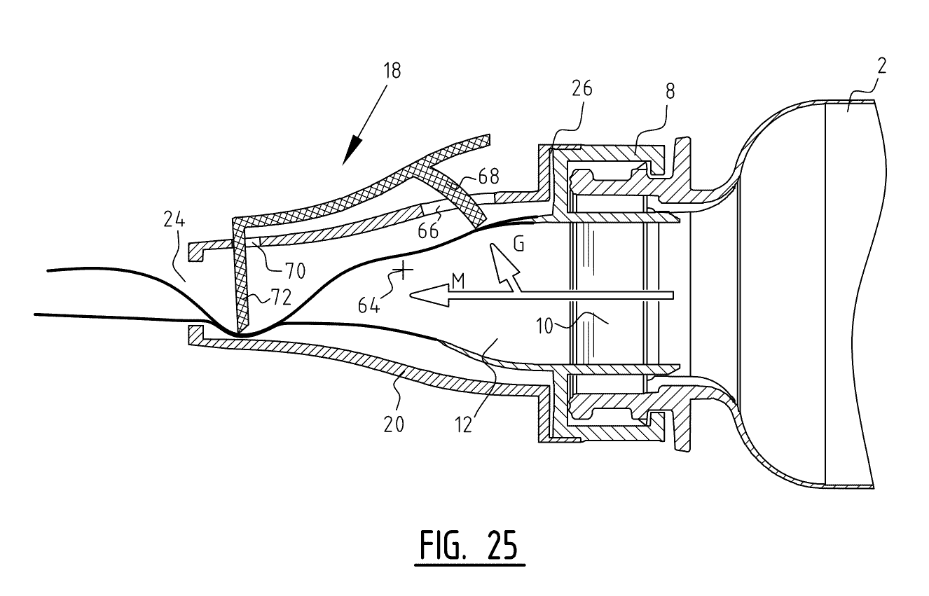

When the force F on clamping element 18 is removed, the medium being displaced from container 2 (as shown by arrow M) in dispensing conduit 12 will exert a force G on protruding part 68 of clamping element 18, which causes this part to pivot about pivot element 64 and close dispensing conduit 12 via clamping part 72. Clamping part 72 displaces for this purpose through recess 70 and clamps dispensing conduit 12 against the inner wall of nozzle housing 20, as shown in FIG. 25, which shows opening 24 of nozzle housing 20 as being now substantially closed.

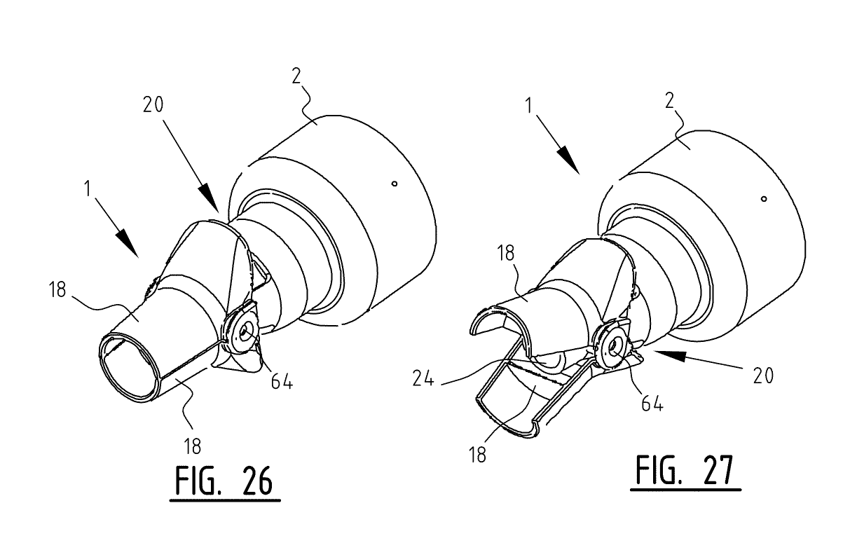

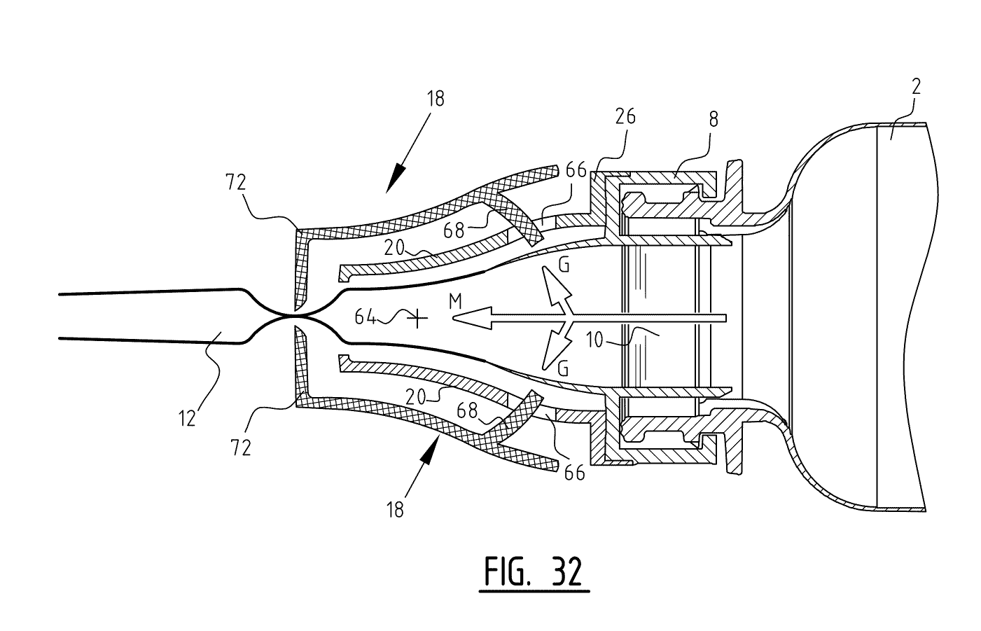

FIGS. 26-32 depict an alternate exemplary embodiment of the automatic nozzle closure dispensing device of FIGS. 19-25 according to the present invention. As shown in FIG. 26, such an exemplary device includes, for example, a double clamping element 18 which operates in a similar manner to the single clamping element device of FIGS. 19-25 described above. For ease of illustration and comparison, corresponding elements in FIGS. 26-32 to those of FIGS. 19-25 have the same reference numerals. Again with reference to FIG. 26, when no force F is exerted on clamping elements 18, these clamping elements in the exemplary embodiment of FIGS. 26-32 also automatically move to a closed position under the influence of a force G exerted by the medium on protruding part 68. Clamping elements 18 pivot about a pivot element 64 and thereby close dispensing conduit 12 shut between clamping parts 72 of clamping elements 18, as shown in FIG. 32.

It is noted at this juncture that the closure of dispensing conduit 12 differs between the exemplary embodiment with single clamping element 18 as shown in FIGS. 19-25 and the exemplary embodiment where two clamping elements 18 are applied as shown in FIGS. 26-32. Using a single clamping element results in the lateral displacement of dispensing conduit 12 until it comes to lie against the inner wall of nozzle housing 20, after which dispensing conduit 12 bends and is closed, as shown in FIG. 25. This is an asymmetrical sealing. On the other hand, when two clamping elements 18 are used, a symmetrical sealing can take place, wherein the normally round, flexible dispensing conduit 12 is pressed flat and shut between clamping elements 18 as shown, for example, in FIG. 32. Because dispensing conduit 12 here in the latter case deforms from round to flat, clamping elements 18 will have to comprise a wider jaw in the case of the symmetrical clamping of FIGS. 26-32 than in the case of the single clamping element of FIGS. 19-25.

Alternatively, as noted above, however, there are numerous various mechanisms that can be used or implemented to close dispensing conduit 12. These include, for example, closing the flexible dispensing conduit 12 by, for example, pushing, pulling, twisting, bending, folding, zippering and fastening or any combination thereof—essentially any closure scheme that can be effected on a plastic bag, which is essentially the degree of flexibility which dispensing conduit 12 has. The key functionality being that the dispensing conduit is sufficiently deformably flexible to be repeatedly capable of a substantially air-tight closure and then re-opening to allow full flow of the medium, and thus, given this deformable flexibility, a wide variety of actual possible closure mechanisms and schemes are available.

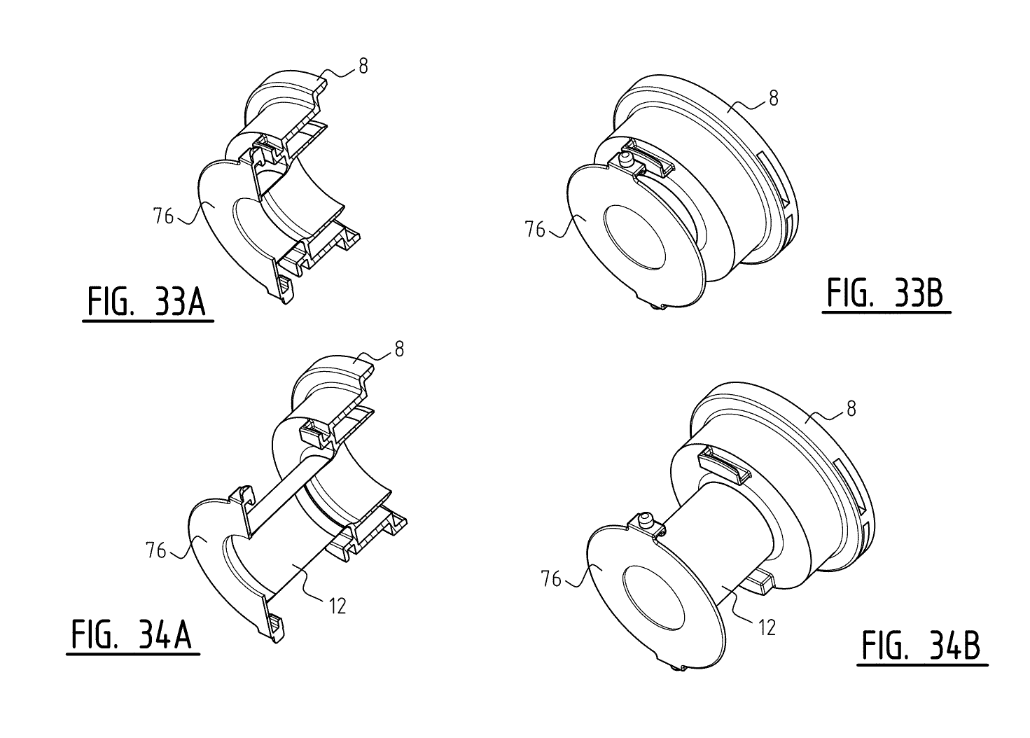

FIGS. 33-39 depict yet another exemplary embodiment of a dispensing device according to the present invention. In the exemplary embodiment of FIGS. 33-39 an injection-molded preform 6 has coupling means 8 and a substantially stiff plate portion 76, as seen in FIGS. 33A and 33B. When this injection-molded preform 6 is stretched, such as, for example, by stretching at least a portion of the injection-molded part to form dispensing conduit 12 in the mold immediately after the injection molding, a substantially thin-walled dispensing conduit 12 can, for example, be formed, as shown in FIGS. 34A, 34B—where the cylindrical structure between coupling means 8 and stiff plate portion 76 has been elongated. Alternatively, for example, the exemplary embodiment shown in FIG. 34 can be injection molded in a single step.

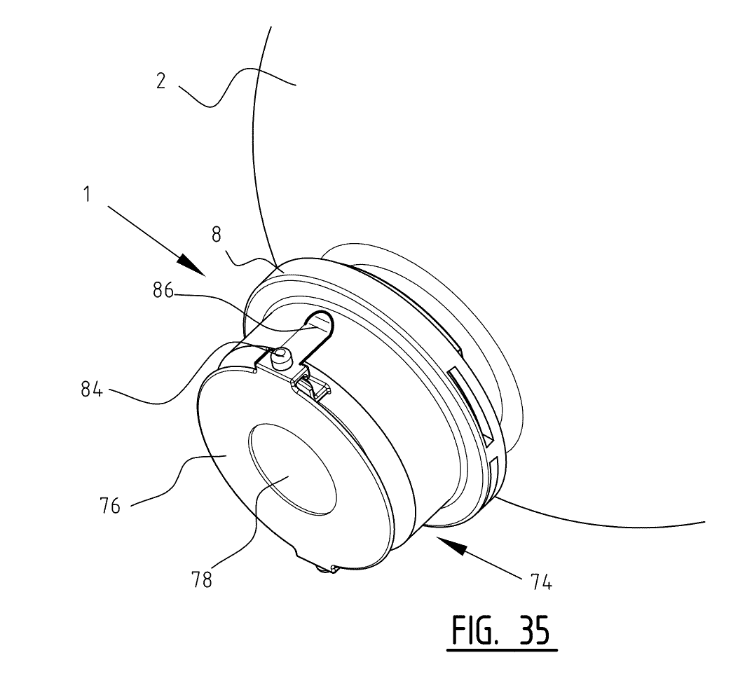

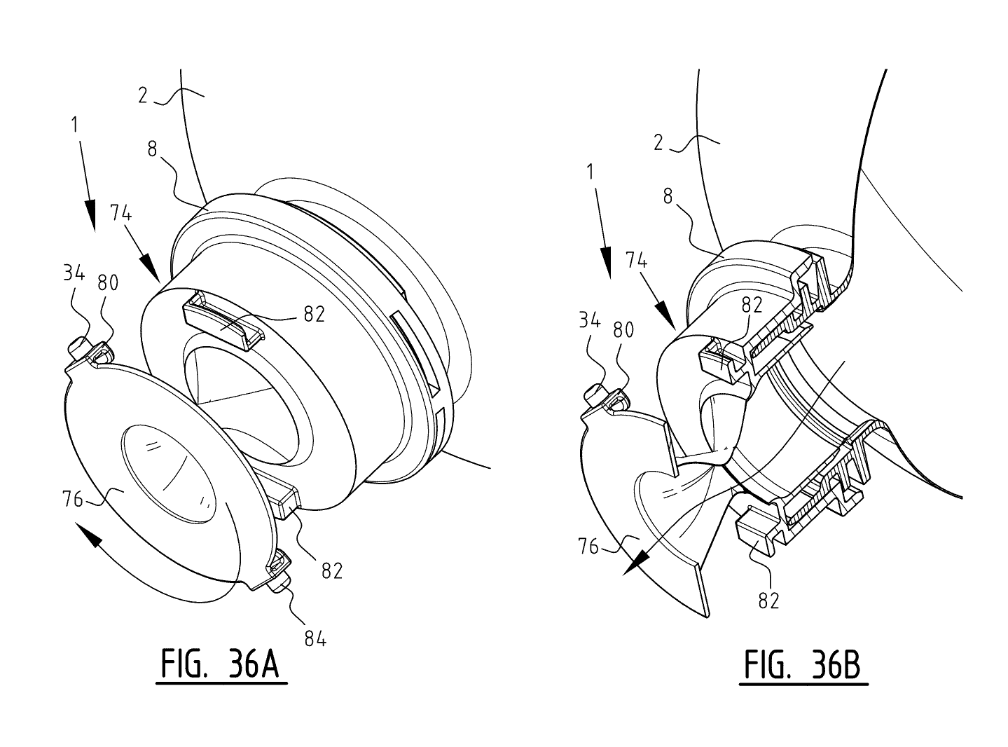

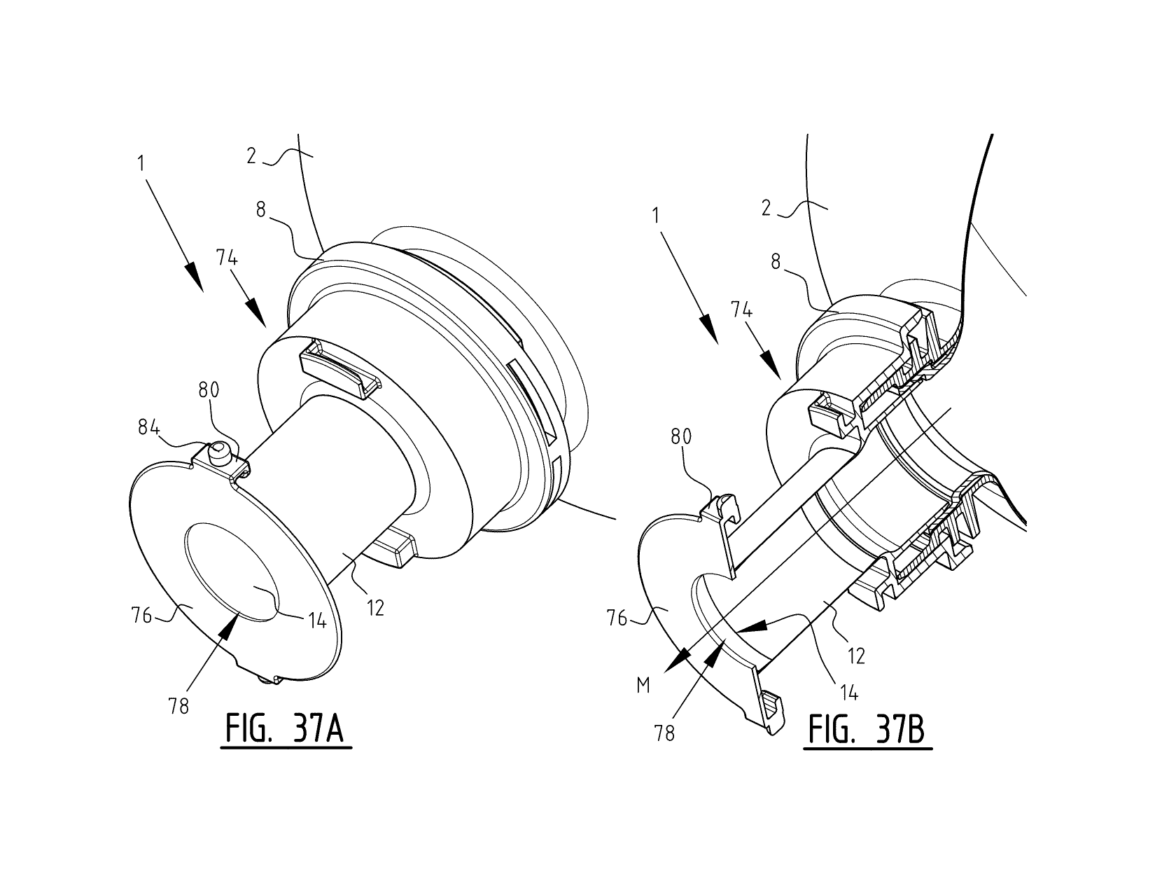

FIG. 35 shows nozzle 1 as mounted, for example, on a container 2. Here coupling means 8 engage on the neck portion of container 2. If desired, for example, a so-called tamper evident seal 86 can be applied to indicate that the packaging has not already been opened. FIG. 36 depicts an opening operation of this exemplary dispensing device. With reference thereto, to open nozzle 1 plate part 76 is rotated relative to nozzle housing 74 as shown by the clockwise arrow. The tamper evident seal 86 (FIG. 35) is or has been broken as a result. Plate part 76 has opening 78 (FIG. 35) and is connected to nozzle housing 74 via dispensing conduit 12. By rotating the stiff plate part as shown in FIG. 36A the dispensing conduit previously stored in twisted position is unraveled into a continuous open position. FIG. 36B, which shows a cut-away view of FIG. 36A, shows dispensing conduit 12 opened to some extent, but when plate part 76 is rotated further in the direction of the arrow in FIG. 36A, it will eventually reach the position shown in FIGS. 37A and 37B, where now completely untwisted (and cylindrical) dispensing conduit 12 allows essentially unimpeded passage of a medium M from container 2 through and out of opening 78 into a user's receptacle, for example.

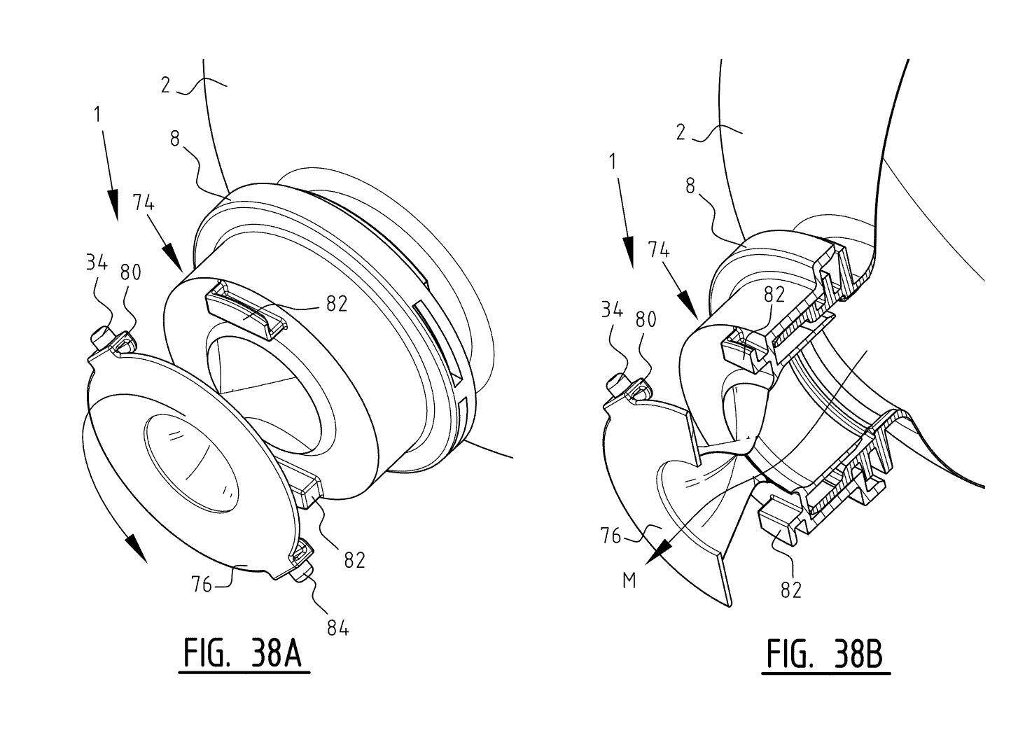

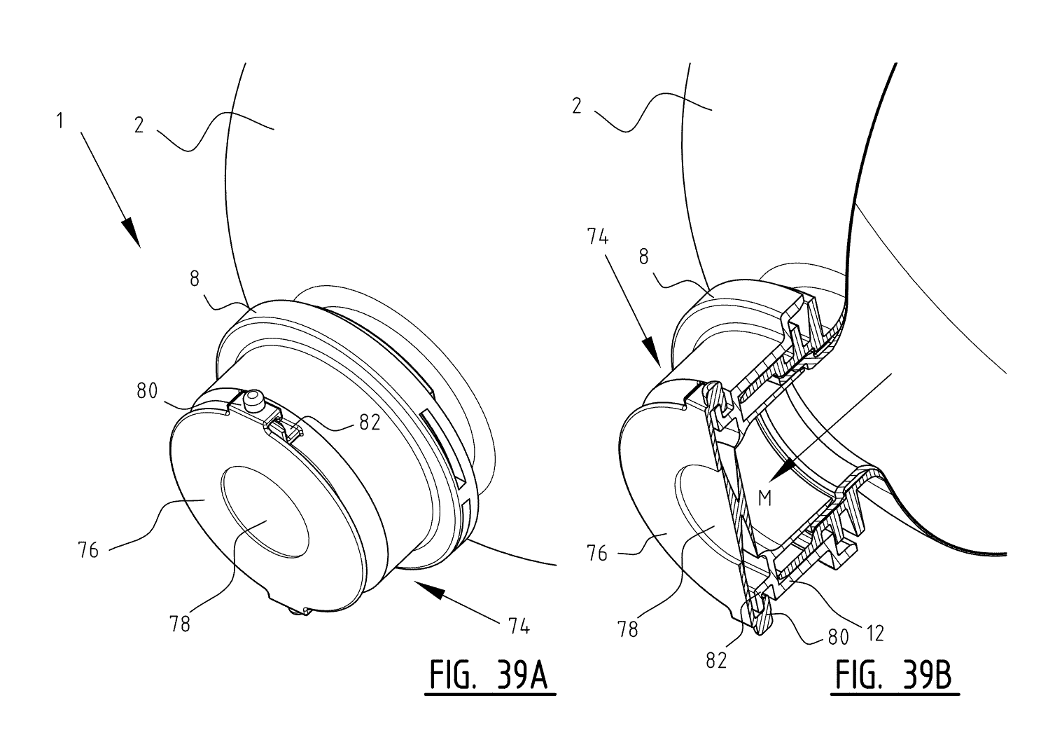

In order to close nozzle device 1, plate part 76 is rotated in the opposite direction relative to nozzle housing 74, as shown, for example, by the now counter-clockwise arrow shown in FIG. 38A. As a result, dispensing conduit 12 is rotated back into its twisted position as shown partially in FIG. 38B and completely in FIGS. 39A and 39B. In this position dispensing conduit 12 is twisted together such that it is fully closed, in a substantially air-tight closure, and thus protects the medium present in container 2 from exposure to the outside air, and therefore drying out. In the position shown in FIG. 39A the stiff plate part 76 can engage with hook-like element 80 on the hook-like element of nozzle housing 82 so that plate part 76 can be locked into its closed position onto nozzle housing 74.

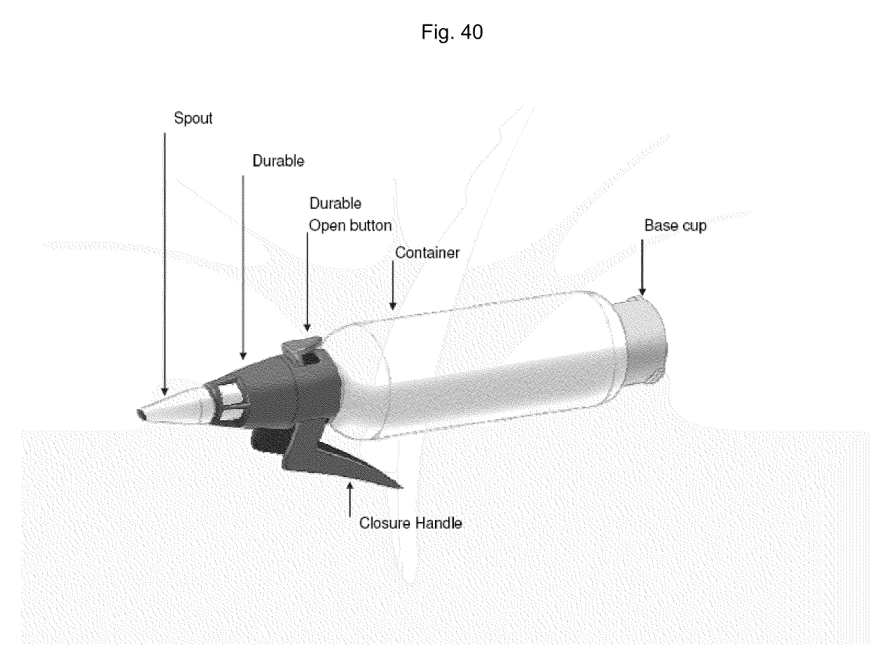

FIGS. 40-44 depict a variant of the exemplary embodiment of FIGS. 19-25 of the present invention. In the exemplary dispensing device of FIGS. 40-44 the open state of the dispensing conduit is when a single closure handle is pulled away from the container. This is the complement to the exemplary embodiment of FIGS. 19-26, where the single handle (which operates a single clamping device) is pushed towards the container to open the dispensing conduit.

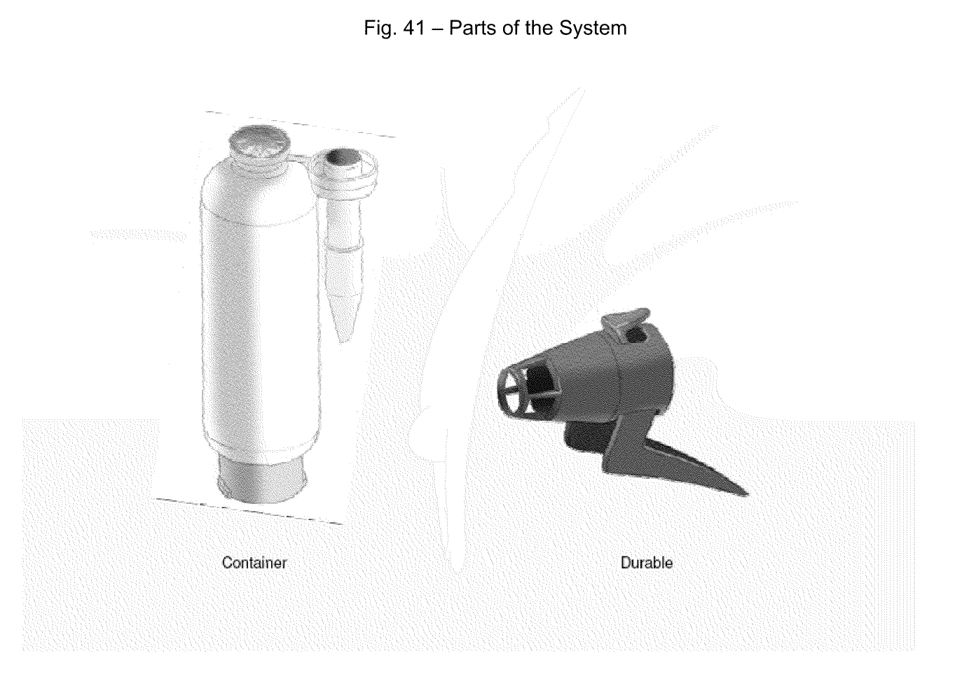

With reference to FIG. 40, the exemplary embodiment includes a Spout, a Durable Portion, a Durable Open Button and a Closure Handle. The dispensing device can be affixed to a Container, and can dispense any medium therefrom, in particular a rather viscous medium as noted above. FIG. 41 depicts the main parts of the exemplary dispensing device. As can been seen with reference thereto, the Durable Portion fits over the container assembly, which includes a container with, for example, a tamper-evident seal, and a spout. The Container has a Base Cup, upon which it can stand, such as, for example, when the container is being pressurized as described below.

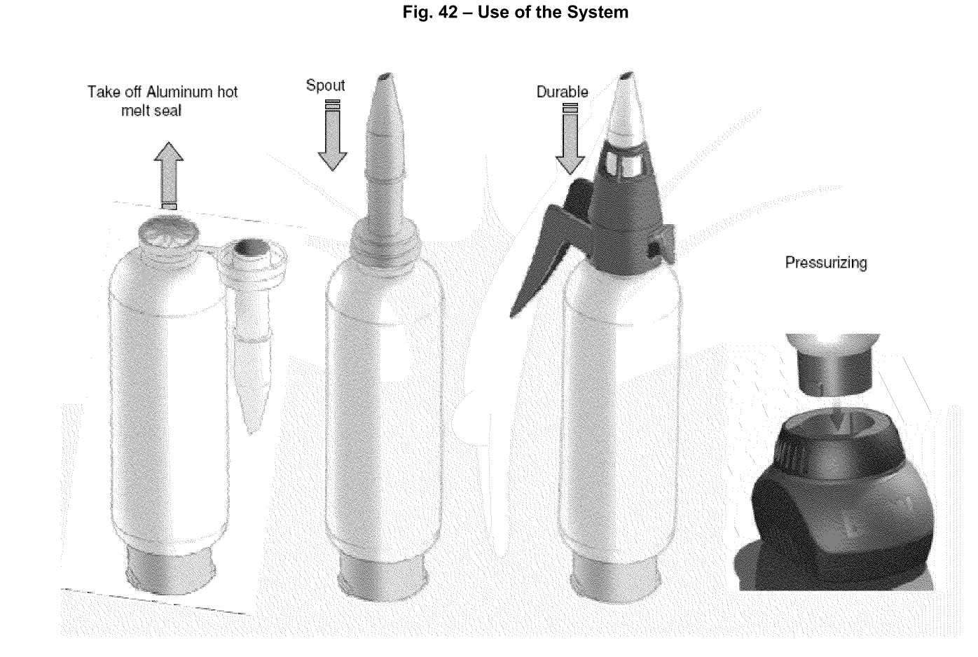

In exemplary embodiments of the present invention the Durable Portion can, for example, be reused, and the container and spout—which contact the medium—can be thrown away after the medium has been fully dispensed. As shown in FIG. 42, to facilitate the dispensing of the medium, the container can have, for example, an inner “bag” or inner container which contains the medium, and there can be a gap between the inner bag or inner container and the outer shell of the container, into which air or other pressurizing medium can be placed so as to continually push the medium out of the container when the dispensing conduit is opened. Such gap can also be, for example, a second inner container into which a pressurizing medium can be provided, for example. For this purpose, for example, a pressurizing device can be used, to pressurize the container prior to dispensing. Such a pressurizing device can, for example, be a base such as is shown in FIG. 42, upon which the bottom of the container can be placed when pressurizing it.

Such first inner container and second inner container technology is sometimes known as Flair® technology, and is provided by Dispensing Technologies B.V., of Helmond, The Netherlands.

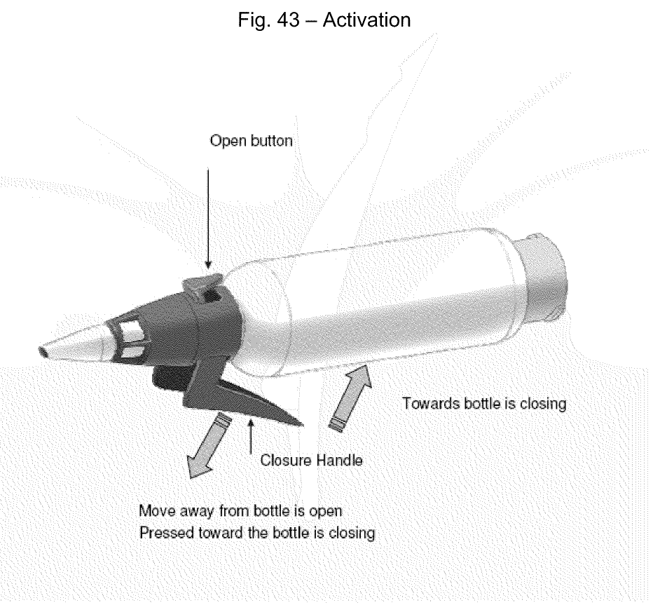

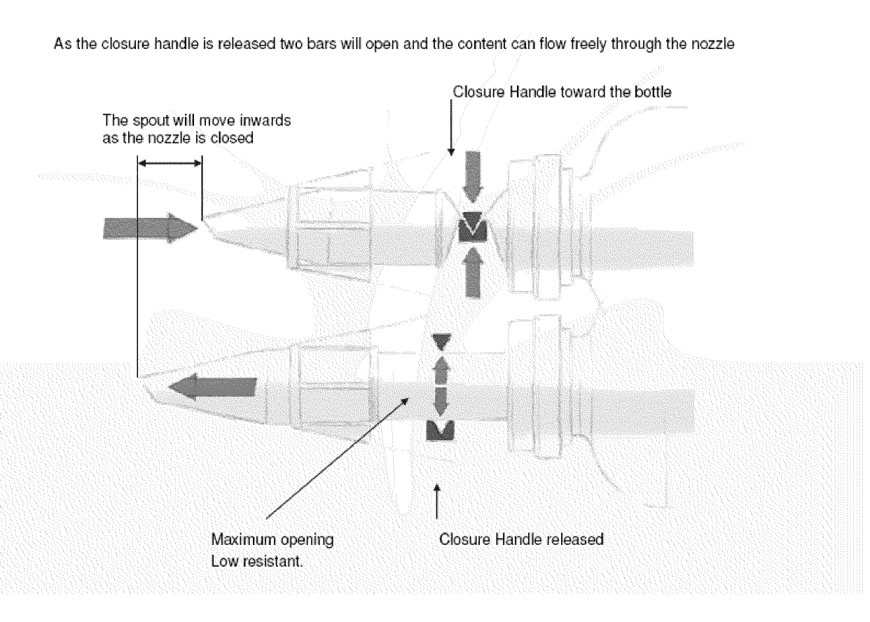

Continuing with reference to FIG. 43, which depicts how the device is activated, when a user moves the closure handle away from the bottle, for example, the dispensing conduit is opened, and the pressurized medium flows out of the container. Similarly, the device is closed when the closure handle is moved towards the bottle. The reason why the opening and closure have this directionality is seen with reference to FIG. 44, next described.

As seen in FIG. 44, there is a closing mechanism comprising a set of pincers which press shut a flexible deformable portion of the Spout. When the Closure Handle is pulled away from the bottle the pincers open, and the medium can freely flow. As noted above, when the container is pressurized, the medium will be assisted in such flow by the applied pressure. Conversely, when the Closure Handle is pushed towards the bottle, in a convenient configuration for storage (without a handle protruding), the pincers are engaged, and no flow of the medium can occur.

Although various exemplary embodiments of the present invention have been described above, the above-presented description and figures are intended by way of example only and are not intended to limit the present invention in any way, except as set forth in the following claims. It is particularly noted that the persons skilled in the art can readily combine the various technical aspects of the various exemplary embodiments described.

1. A device for dispensing a medium from a container, comprising:
at least one opening;
a dispensing conduit; and
a coupling connecting the dispensing conduit to the opening;
wherein the dispensing conduit is flexibly deformable such that:
in an open position the medium passes through it without obstruction, and
in a closed position the device is substantially air-tight.

2. The device of claim 1, wherein the dispensing conduit is twistably deformable, in its open position it is cylindrical, with essentially uniform cross-sectional area along its length, and in its closed position its cross-sectional area is non-uniform along its length, and crimps to a minimum where it is substantially air-tight.

3. The device of claim 2, wherein the dispensing conduit is fixed at its proximal end to a nozzle housing and is provided with a plate portion at its distal end, and wherein the plate portion and the nozzle housing are rotatable relative to each other such that:
at no relative rotation the dispensing conduit is in the open position; and
at maximum relative rotation the dispensing conduit is in the closed position.

4. The device of claim 3, further comprising locking means for locking the plate portion to the nozzle housing in the closed position.

5. The device of claim 1, wherein the coupling and the dispensing conduit are at least one of (i) integrally manufactured, (ii) separately manufactured and (iii) manufactured from the same material.

6. (canceled)

7. The device of claim 1, wherein the coupling and/or the dispensing conduit are manufactured from thermoplastic materials, said thermoplastic materials including polyolefins, polyamides, thermoplastic polyester elastomer (TPE) and polyethylene terephthalate (PET), or any combinations thereof.

8. The device of claim 1, wherein the dispensing conduit has a wall thickness of between 0.02 mm and 1.5 mm.

9. The device of claim 1, wherein the dispensing conduit further comprises a closure, said closure comprising at least one clamping element for pressing shut the dispensing conduit.

10. The device of claim 9, further comprising a substantially form-retaining nozzle housing arranged on the coupling, through which the dispensing conduit is guided.

11. The device of claim 10, wherein the at least one clamping element presses the dispensing conduit shut against an inner wall of the substantially form-retaining nozzle housing.

12. (canceled)

13. The device of claim 1, wherein the closure comprises at least two clamping elements, and wherein in a closed position the dispensing conduit is pressed shut between them.

14. The device of claim 9, wherein the clamping element is a wheel, ball or slide displaceable in the nozzle housing.

15-19. (canceled)

20. A container provided with the dispensing device of claim 1.

21. (canceled)

22. A method of manufacturing the device of claim 1, comprising:
injection molding the coupling and the dispensing conduit in one operation as a preform; and
stretching, blowing or performing any combination of stretching and blowing, a portion of the preform so as to obtain a substantially flexibly deformable, thin-walled dispensing conduit.

23. The method of claim 22, wherein the dispensing conduit is stretched while the preform is one of (i) still in the mold and (ii) no longer in the mold.

24. The method of claim 22, wherein at least the dispensing conduit is injection molded from one or more thermoplastic materials, said thermoplastic materials including polyolefins, polyamides, thermoplastic polyester elastomer (TPE) and polyethylene terephthalate (PET), or any combinations thereof.

25. (canceled)

26. A container for dispensing a medium, comprising:
a disposable spout including a dispensing conduit; and
a non-disposable portion including a closure mechanism,
wherein the container is pre-filled with a medium, has a removable seal at its top, and wherein the spout is removably attached to the container.

27-29. (canceled)

30. The device of claim 26, wherein in operation the spout is affixed by a user to the container, and the durable portion is slid over the spout and affixed to a neck of the container.

31. The device of claim 26, wherein the container comprises a first inner container and a second inner container, and wherein the first inner container is filled with the medium, and the second inner container is provided with a pressurizing medium.

32. The device of claim 31, wherein the pressurizing medium is air, and the second inner container is pressurized by at least one of placing the container on a compressor, applying energy via pump or piston, wringing, squeezing and turning, or any combination thereof

33. The device of claim 26, wherein at least the spout is injection molded from one or more thermoplastic materials, said thermoplastic materials including polyolefins, polyamides, thermoplastic polyester elastomer (TPE) and polyethylene terephthalate (PET), or any combinations thereof.

34. (canceled)

35. The device of claim 33, wherein the spout is injection molded as a preform, and wherein after said injection molding a portion of the preform is stretched, blown or processed by any combination of stretching and blowing, so as to obtain a substantially flexibly deformable, thin-walled dispensing conduit.

36. (canceled)

37. The device of claim 1, further comprising a closure, wherein said closure operates to close the dispensing conduit by one of pushing, pulling, bending, folding, zippering and fastening, or any combination thereof, wherein said closing can be repeatedly performed, and wherein the device can be re-opened so as to allow full flow of the medium after each such closure.

38-39. (canceled)
